(19) United States
(12) Patent Application Publication
(10) Pub. No.: US 2004/0069207 A1
(43) Pub. Date: Apr. 15, 2004

(54) Bookmark

(76) Inventor: JoAnn Pearl Forance, Fort Myers, FL (US)

Correspondence Address: William E. Noonan, Post Office Box 07338, Fort Myers, FL, 33919, US

(21) Appl. No.: 10/270,431

(22) Filed: Oct. 15, 2002

(51) Int. Cl. B42D 9/00

(52) U.S. Cl. 116/238

(57) ABSTRACT

The invention relieves readers' frustration of conventional bookmarks that do not stay in place or become lost when placed outside the book. The invention is designed to be an unobtrusive object that is neat, small and compact; it is made from a two to one stretch material with a loop that will hug the back cover of the book while a tail marks the reader's spot. Most individual readers would use the single strand unit while college students, law offices, etc. would use the multiple strands unit to mark several areas within a large reference manual or oversize text book.

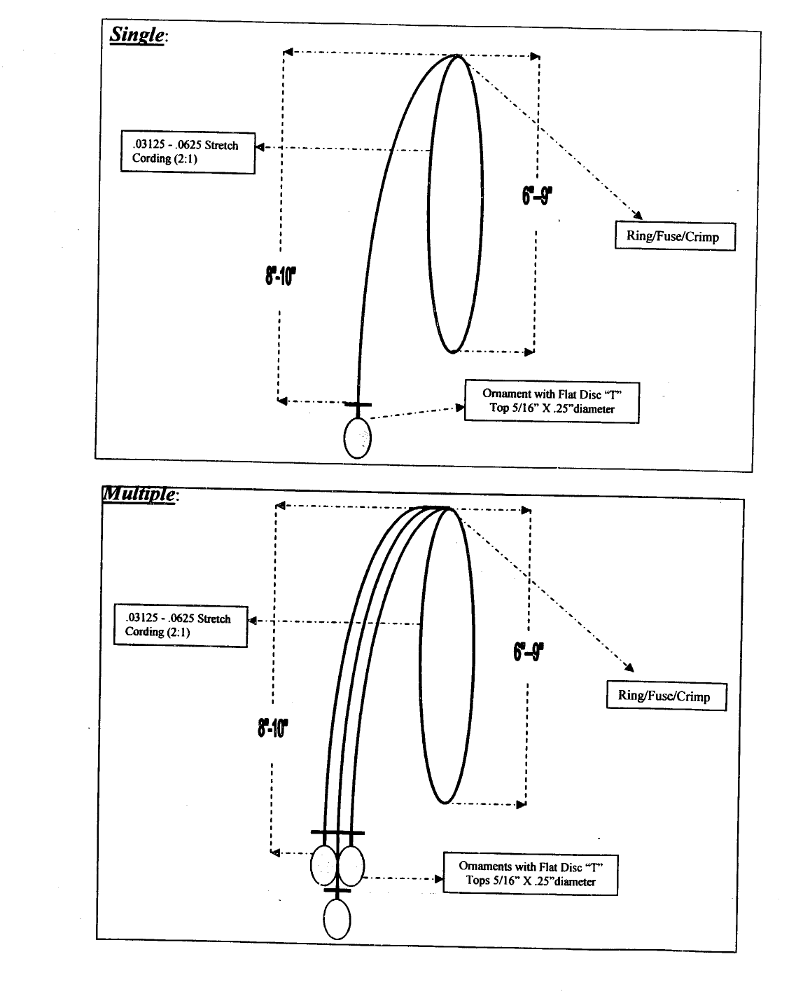

### BACKGROUND OF INVENTION

The intent of the invention is to relieve the frustration of bookmarks that do not stay in place but fall to the floor when the book is moved or accidentally dropped; it will also prevent the loss of the conventional bookmark when it is placed outside the book. The goal is to develop a simple article that would be inexpensive and serve the purpose. The invention is designed to be small and compact. The single strand unit would service most individual readers while the multiple strands unit would provide college students, law offices, etc. with a neat way to mark several areas within a large reference manual or oversize text book.

### BRIEF SUMMARY OF THE INVENTION

This invention is a simplified bookmark that is unobtrusive, consisting of elastic cording stretched lengthwise through the book. The cording is looped with single or multiple tails. On the tail, which hangs out of the page, various markers, identifiers, beads or tassels can be, optionally, adhered, fused or bound. The advantage of this invention, compared to the conventional bookmarks, is that it will never drop out of the book, become lost or tattered and will always mark the place of reference. Unlike the conventional bookmarks this unit temporarily attaches to the back cover of the book becoming a part of the book until such time as the reader desires to remove it.

### DETAILED DESCRIPTION OF THE INVENTION

A single strand of elasticized cording with a two to one stretch is looped and fused, crimped or bound creating a loop and a tail(s). The loop will be applied to the back cover of a book circling from the outside of the back cover to the inside of the back cover with the tail(s) projecting out from the top of the book. The bookmark temporarily attaches to the back cover of the book becoming a part of the book until it is removed by the reader. The tail(s) then can be freely placed along the inside seam of any page of the book to MARK the reader's places. Flat disc(s) or flat, fused, crimped or bound cording at the bottom of the tail(s) will hold the bookmark(s) in place with a light stretch. Approximately 1.5 inches of the tail(s) will extend beyond the disc(s) allowing approximately 0.75 inches for an ornamental addition(s) or marker(s). This extension will form tab(s) at the end of the tail(s) which the reader can manipulate and position as a marker(s). While reading the book the reader will PARK the bookmark(s) (tail(s)) between the last page and back cover of the book where it (they) will stay put because of the slight stretch.

1. What I claim as my invention is a reusable, stay-in-place, unobtrusive, temporarily attachable, convenient bookmark which will maintain the place(s) of reference, will become part of the book until removed by the reader and will not drop out of the book, become lost or tattered.
